(19) United States
(12) Patent Application Publication
(10) Pub. No.: US 2015/0253884 A1
(43) Pub. Date: Sep. 10, 2015

(54) DETERMINATION OF BEZEL AREA ON FLEXIBLE DISPLAY

(71) Applicant: Sung Jae HWANG, Daejeon (KR)

(72) Inventor: Sung Jae HWANG, Daejeon (KR)

(21) Appl. No.: 14/454,991

(22) Filed: Aug. 8, 2014

(30) Foreign Application Priority Data
Mar. 4, 2014 (KR) 10-2014-0025578

(51) Int. Cl. G06F 3/041

(52) U.S. Cl. CPC G06F 3/041; G06F 2203/04102

(57) ABSTRACT

A flexible device may include a flexible display; a sensor configured to detect at least one physical action applied to the flexible display; a display manager configured to: determine a first area and a second area on the flexible display based, at least in part, on the detected at least one physical action; and determine a first display property of the first area to be different from a second display property of the second area; and a processor configured to instruct the flexible display to display content based, at least in part, on the first and second display properties.

### CROSS-REFERENCE TO RELATED PATENT APPLICATION

This application claims priority from the Korean Patent Application No. 10-2014-0025578, filed on Mar. 4, 2014 in the Korean Intellectual Property Office, the entire disclosure of which is incorporated herein by reference in its entirety.

### FIELD

Example embodiments broadly relate to a device having a bezel displayed on a flexible display.

### BACKGROUND

Flexible display (also may refer to “rollable display,” “foldable display,” “stretchable display,” “cuttable display,” “attachable display” or “detachable display”) may be used to display content including graphics and text even when the flexible display is folded or rolled. The flexible display may have relative higher durability from the external forces. Flexible displays will be becoming more popular for use as displays of electronic devices, such as laptop computer, monitor, television, mobile telephones or personal digital assistants (PDAs).

### SUMMARY

According to an aspect of example embodiments, there is provided a flexible device including a flexible display; a sensor configured to detect at least one physical action applied to the flexible display; a display manager configured to: determine a first area and a second area on the flexible display based, at least in part, on the detected at least one physical action, and determine a first display property of the first area to be different from a second display property of the second area; and a processor configured to: instruct the flexible display to display content based, at least in part, on the first and second display properties.

In some examples, the at least one physical action may include a stretching action. The display manager may be further configured to: determine the first area to include an area stretched by the stretching action. In some other examples, the at least one physical action may include at least one of an attaching action, a detaching action or a cutting action.

The sensor may be further configured to detect at least one value caused by the at least one physical action, and the display manager may be further configured to determine the first area and the second area based, at least in part, on the detected at least one value.

The display manager may be further configured to determine that the at least one value is higher than a predetermined threshold value; and determine the first area, in response to the determination that the at least one value is higher than the predetermined threshold value.

The first or second display property may include at least one of a brightness, a resolution, a transparency, a visibility or a chroma of the first or second area.

The display manager may be further configured to: divide the first area into a plurality of sub-areas; and respectively determine a display property of each of the plurality of sub-areas.

The flexible display may include a touch screen, and the display manager is further configured to determine a touch sensing property of the first area to be different from that of the second area.

The processor may be further configured to instruct the flexible display to display the content on both of the first area and the second area based, at least in part, on the first and second display properties, respectively.

According to another aspect of example embodiments, there is provided computer-readable storage medium having thereon computer-executable instructions that, in response to execution, cause one or more processors of a flexible device having a flexible display to perform operations including detecting at least one physical action applied to the flexible display; determining a first area and a second area on the flexible display based, at least in part, on the detected at least one physical action; determining a first display property of the first area to be different from a second display property of the second area; and displaying content on the flexible display based, at least in part, on the first and second display properties.

The detecting the at least one physical action may include detecting at least one value caused by the at least one physical action. The determining the first area and the second area may include determine that the at least one value is higher than a predetermined threshold value, and determining the first area, in response to the determination that the at least one value is higher than the predetermined threshold value.

The first or second display property may include at least one of a brightness, a resolution, a transparency, a visibility or a chroma of the first or second area.

According to still another aspect of example embodiments, a method performed under control of a flexible device having a flexible display may include: detecting at least one physical action applied to the flexible display; determining a first area and a second area on the flexible display based, at least in part, on the detected at least one physical action; determining a first display property of the first area to be different from a second display property of the second area; and displaying content on the flexible display based, at least in part, on the first and second display properties.

The determining of the first area and the second area may include determining a size and/or a position of the first area based at least in part on context information of the end device.

The detecting the at least one physical action may include detecting at least one value caused by the at least one physical action, and determining the first area and the second area may include determine that the at least one value is higher than a predetermined threshold value and determining the first area, in response to the determination that the at least one value is higher than the predetermined threshold value.

The displaying content may include displaying the content on both of the first area and the second area based, at least in part, on the first and second display properties, respectively.

### BRIEF DESCRIPTION OF THE DRAWINGS

Non-limiting and non-exhaustive example embodiments will be described in conjunction with the accompanying drawings. Understanding that these drawings depict only example embodiments and are, therefore, not intended to limit its scope, the example embodiments will be described with specificity and detail taken in conjunction with the accompanying drawings, in which:

FIG. 1 schematically shows an example configuration of a flexible device in accordance with at least some embodiments described herein;

FIG. 2 schematically shows an illustrative example of a flexible display in accordance with at least some embodiments described herein;

FIG. 3 schematically shows another illustrative example of a flexible display in accordance with at least some embodiments described herein;

FIG. 4 schematically shows illustrative example of a flexible device in accordance with at least some embodiments described herein;

FIGS. 5A to 5C schematically show other illustrative examples of a flexible device in accordance with at least some embodiments described herein;

FIG. 6 schematically shows another example configuration of a flexible device in accordance with at least some embodiments described herein;

FIG. 7 schematically shows an example configuration of a bezel control manager in accordance with at least some embodiments described herein; and

FIG. 8 shows an example processing flow for implementing at least portions of a bezel area on a flexible display described herein.

### DETAILED DESCRIPTION

Hereinafter, some embodiments will be described in detail. It is to be understood that the following description is given only for the purpose of illustration and is not to be taken in a limiting sense. The scope of the invention is not intended to be limited by the embodiments described hereinafter with reference to the accompanying drawings, but is intended to be limited only by the appended claims and equivalents thereof.

It is also to be understood that in the following description of embodiments any direct connection or coupling between functional blocks, devices, components, circuit elements or other physical or functional units shown in the drawings or described herein could also be implemented by an indirect connection or coupling, i.e. a connection or coupling comprising one or more intervening elements. Furthermore, it should be appreciated that functional blocks or units shown in the drawings may be implemented as separate circuits in some embodiments, but may also be fully or partially implemented in a common circuit in other embodiments. In other words, the provision of functional blocks in the drawings is intended to give a clear understanding of the various functions performed, but is not to be construed as indicating that the corresponding functions are necessarily implemented in physically separate entities.

It is further to be understood that any connection which is described as being wire-based in the following specification may also be implemented as a wireless communication connection unless noted to the contrary.

The features of the various embodiments described herein may be combined with each other unless specifically noted otherwise. On the other hand, describing an embodiment with a plurality of features is not to be construed as indicating that all those features are necessary for practicing the present invention, as other embodiments may comprise less features and/or alternative features.

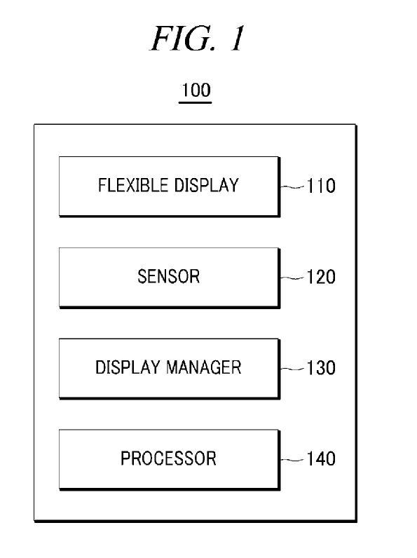

FIG. 1 schematically shows an example configuration of a flexible device 100 in accordance with at least some embodiments described herein. As depicted in FIG. 1, flexible device 100 may include a flexible display 110, a sensor 120, a display manager 130 and a processor 140. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof. In that regard, one or more of display manager 130 and processor 140 may be included in an instance of an application hosted on flexible device 100.

Non-limiting examples of flexible device 100 may include a digital signage, an electronic-paper, an electronic-reader, a smart phone, a smart television, a monitor, a tablet computer, a phablet device, a mobile phone, or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminal.

Flexible display 110 may be configured to display a bezel area (sometimes, referred to as a first area) and a normal area (sometimes, referred to as a second area). As referenced herein, the bezel area may refer to an area that may have a first display property different from a second display property of the normal area. In some examples, content may be displayed on the bezel area with the first display property as well as the normal area with the second display property. For example, but not as a limitation, the first and second display properties may refer to at least one of a brightness, a resolution, a transparency, a visibility or a chroma. The bezel area may be positioned to surround the normal area or to be disposed at an edge of the normal area. Further, the normal area may refer to an area that may be configured to display content thereon as like an ordinary display device. By way of example, but not as a limitation, flexible display 110 may use liquid crystal display (LCD) technology, light emitting diode (LED) technology, organic light emitting diode (OLED) technology or light emitting polymer display (LPD) technology, plasma display technology, field emission display (FED) technology, electroluminescence display (ELD) technology, etc.

In further some examples, flexible display 110 may include touch screen which may have a touch-sensitive surface that receives a touch input. The touch screen may be configured to receive the touch input to the touch-sensitive surface and convert the touch input into interaction with user-interface objects that are displayed on flexible display 110. In such examples, the bezel area may have a touch sensing property which is different from that of the normal area. By way of examples, but not limitation, the touch sensing property may include at least one of a touch sensitivity or turn on/off of touch sensors formed under the bezel area.

Sensor 120 may be configured to detect at least one physical action applied to flexible display 110. For example, but not limitation, sensor 120 may include at least one of a pressure sensor, a gyro sensor, a magnetic sensor, an optical sensor, a thermal sensor, an acoustic sensor, etc. Further, the at least one physical action may include, but not limitation, at least one of a folding action, a bending action, a stretching action, an attaching action, a detaching action or a cutting action.

Display manager 130 may be configured to determine the bezel area and the normal area on flexible display 110 based, at least in part, on the at least one physical action detected by sensor 120. Specifically, display manager 130 may be configured to determine sizes and/or positions of the bezel area and the normal area on touch screen 110 based, at least in part, on the detected at least one physical action, and to display the bezel area and the normal area based on the determined sizes and/or positions.

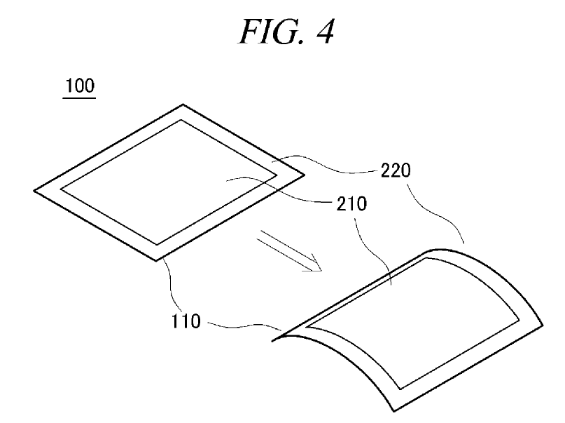

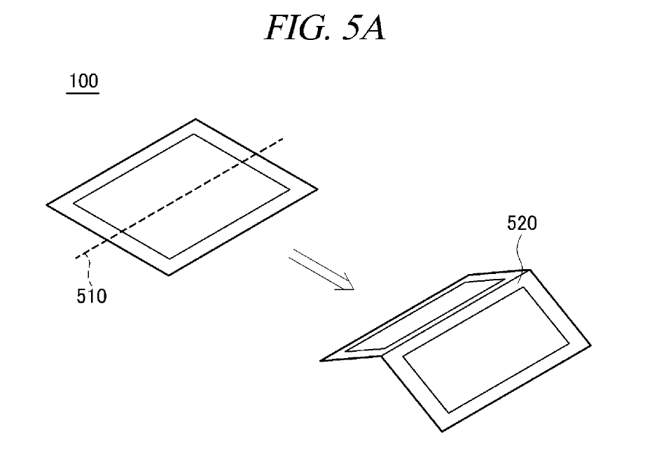

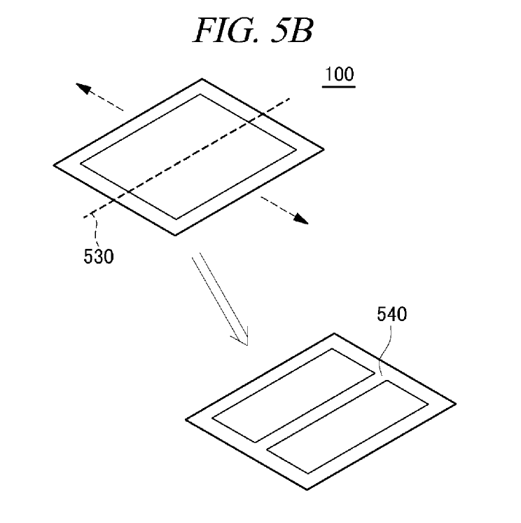

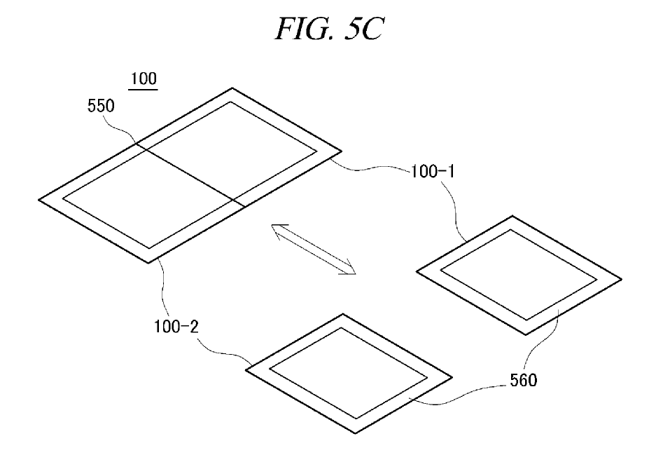

In some example, display manager 130 may be configured to determine the bezel area based, at least in part, on the at least one physical action. More specifically, sensor 120 may be configured to detect a folding action. In such examples, display manager 130 may be configured to determine the bezel area to include an area folded by the folding action. In some other examples, sensor 120 may be configured to detect a stretching action, and then display manager 130 may be configured to determine the bezel area to include an area stretched by the stretching action. Various examples regarding detecting a physical action and determining the bezel area will be described in more details with reference to FIGS. 4 and 5A-5C below.

In some embodiments, sensor 120 may be further configured to detect at least one value caused by the at least one physical action and display manager 130 may be further configured to determine the bezel area and the normal area based, at least in part, on the detected at least one value. In some examples, display manager 130 may be further configured to determine that the at least one value is higher than a predetermined threshold value, and to determine the bezel area, in response to the determination that the at least one value is higher than the predetermined threshold value.

Display manager 130 may be configured to determine a first display property of the bezel area to be different from a second display property of the normal area. For example, but not as a limitation, the first and second display properties may refer to at least one of a brightness, a resolution, a transparency, a visibility or a chroma of the bezel area. In some embodiments, display manager 130 may be configured to determine the first display property of the bezel area based, at least in part, on the detected at least one physical action. For example, display manager 130 may be configured to decrease a resolution of a part of an image displayed on the bezel area. For another example, display manager 130 may be configured to decrease a transparency of the bezel area, when a background image of an application, which is relatively inconsequential, is displayed on the bezel area.

Further, in some embodiments, display manager 130 may be configured to divide the bezel area into multiple sub areas. Display manager 130 may be further configured to determine and change the display property of each of the multiple sub areas respectively. Thus, in some embodiments, a gradation may be generated and displayed on the bezel area in association with a position, on flexible display 110, of each of the multiple sub areas. For example, but not as a limitation, the more a position of a sub area is distant from an edge of flexible display 110, the more the brightness of the sub area is increased. Thus, a gradation of brightness may be generated on the bezel area displayed on flexible display 110.

In some embodiments that flexible display 110 includes a touch screen, display manager 130 may be configured to determine a touch sensing property of the bezel area to be different from that of the normal area. For example, but not as a limitation, the touch sensing property of the bezel area may include at least one of a touch sensitivity of the bezel area, or turn on/off of touch sensors of the bezel area. In some embodiments, display manager 130 may be configured to determine the touch sensing property of the bezel area based, at least in part, on the at least one physical action detected by sensor 120. For example, display manager 130 may be configured to increase or decrease a touch sensitivity of the bezel area, depending on a kind of an application hosted on flexible device 100. Display manager 130 may be configured to increase or decrease the touch sensitivity of the bezel area. For another example, display manager 130 may be configured to turn off touch sensors formed under at least a portion of the bezel, when content which does not require a touch interface/interaction is displayed on the bezel area and a hand or a finger of a user of flexible device 100 is touched to the bezel area.

Processor 140 may be configured to instruct flexible display 110 to display content based, at least in part, on the bezel area and the normal area. As a non-limiting example of the content displayed on the bezel area and the normal area may include a text, a picture, a frame or a scene of video content, etc. Flexible device 100 may receive the content from outside of flexible device 100 via a network. The network may be an interconnected structure of nodes, such as terminals and servers, and allows sharing of information among the nodes. Non-limiting examples of the network may include a wired network protocol, such as LAN (Local Area Network), WAN (Wide Area Network), VAN (Value Added Network), etc.; or various other wireless network protocols, such as a mobile radio communication network including at least one of a 3rd generation (3G) mobile telecommunications network, a 4th or 5th generation mobile telecommunications network, any other mobile telecommunications networks, a satellite network, WiBro (Wireless Broadband Internet), a Wi-Fi network, Mobile WiMAX, HSDPA (High Speed Downlink Packet Access) or the like. In further examples, processor 140 may be further configured to instruct flexible display 110 to display the content on both of the bezel area and the normal area, at least in part, on the first and second display properties, respectively.

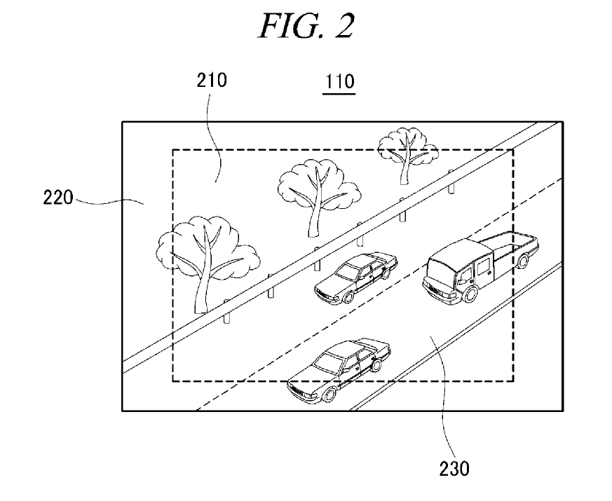

FIG. 2 schematically shows an illustrative example of flexible display 110 in accordance with at least some embodiments described herein. A flexible device, such as flexible device 100 may be configured to determine a normal area 210 and a bezel area 220 on flexible display 110. As depicted in FIG. 2, flexible display 110 may be configured to display content 230 on normal area 210 and on bezel area 220. Although, in FIG. 2, it seems like that there is no difference between normal area 210 and bezel area 220 except that bezel area 220 surrounds normal area 210, a display property of normal area 210 may be different from that of bezel area 220. For example, but not as a limitation, a brightness of bezel area 220 may be lower than a brightness of normal area 210. Further, in some examples that flexible display 110 includes a touch screen, a touch sensing property of normal area 210 may be different from that of bezel area 220. For example, but not limitation, touch sensors within normal area 210 may be turned on, while touch sensors within bezel area 220 may be turned off.

Although, in FIG. 2, bezel area 220 is depicted to have a rectangular contour (i.e., a dashed line in FIG. 2), the contour of bezel area 220 may be changed and may have a variety of shapes, such as a circular shape, a star shape, a triangular shape, etc. Further, although, in FIG. 2, bezel area 220 is depicted to surround normal area 210, a size or a position of bezel area 220 may be changed. For example, but not as a limitation, normal area 210 may take possession of a left side half of flexible display 110 and bezel area 220 may take possession of a right side half of flexible display 110. For another example, normal area 210 may take possession of an upper part of flexible display 110 and bezel area 220 may take possession of a remaining lower part of flexible display 110.

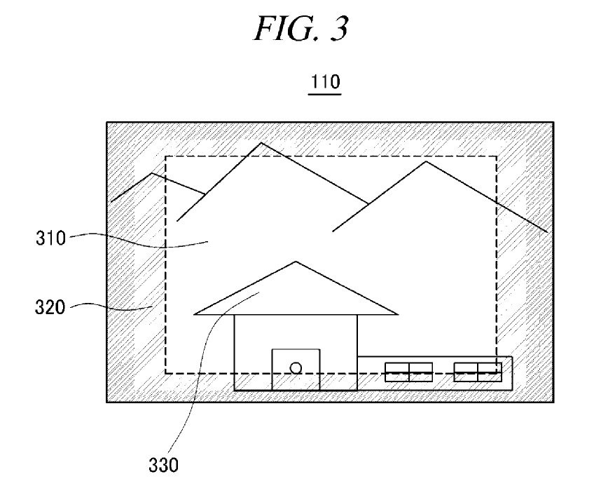

FIG. 3 schematically shows another illustrative example of flexible display 110 in accordance with at least some embodiments described herein. A flexible device, such as flexible device 100 may be configured to determine a normal area 310 and a bezel area 320 on flexible display 110. As depicted in FIG. 3, flexible display 110 may be configured to display content 330 on normal area 310 as well as bezel area 320. Further, the flexible device may be configured to determine a display property of bezel area 320, so the display property of bezel area 320 may be different from that of normal area 310. Non-limiting examples of the display property may include at least one of a brightness, a resolution, a transparency, a visibility or a chroma. For example, but not as a limitation, as depicted in FIG. 3, flexible display 110 may be configured to display content 330 to decrease at least one of a brightness, a resolution, a transparency, a visibility or a chroma of a part of content 330, which is displayed on bezel area 320, as compared to the other part of content 330, which is displayed on normal area 310. Further, in some examples that flexible display 110 includes a touch screen, a touch sensing property of normal area 210 may be different from that of bezel area 220. For example, a touch sensitivity of bezel area 320 may be lower than a touch sensitivity of normal area 310. Alternatively, touch sensors corresponding to normal area 310 may be turned on, but, touch sensors corresponding to bezel area 320 may be turned off.

Further, flexible display 110 may be configured to display content 330 to divide bezel area 320 into multiple sub-areas. Flexible display 110 may be further configured to display content 330 to respectively determine the display property of each of the multiple sub-areas of bezel area 320. For example, but not as a limitation, as depicted in FIG. 3, the flexible device may be configured to divide bezel area 320 into two sub-areas. Further, the flexible device may be configured to determine at least one of a brightness, a resolution, a transparency, a visibility or a chroma of the two sub-areas to be different from each other.

Although, in FIG. 3, bezel area 320 is depicted to have a rectangular contour (i.e., a dashed line in FIG. 3), the contour of bezel area 320 may be changed and may have a variety of shapes, such as a circular shape, a star shape, a triangular shape, etc. Further, although, in FIG. 3, bezel area 320 is depicted to surround normal area 310, a size or a position of bezel area 320 may be changed.

FIG. 4 schematically shows illustrative example of flexible device 100 in accordance with at least some embodiments described herein. For the purpose of simplification, although, in FIG. 4, flexible device 100 is depicted to display no content on flexible display 110, flexible device 100 may display content normal area 210 and bezel area 220 on flexible display 110. Flexible device 100 may be configured to display content on normal area 210 and bezel area 220 on flexible display 110 even though at least one physical action is applied to flexible display 110. In some examples, when the bending action which is weaker than a predetermined level is applied to flexible display 110 or a value caused by the bending action applied to flexible display 110 is lower than a predetermined value, flexible device 100 may maintain normal area 210 and bezel area 220 on flexible display 220 as depicted in FIG. 4.

FIGS. 5A to 5C schematically show other illustrative examples of flexible device 100 in accordance with at least some embodiments described herein. In some examples, at least one physical action which is stronger than a predetermined level may be applied to flexible display 110 or a value caused by the at least one physical action applied to flexible display 110 may be higher than a predetermined value. In such examples, flexible device 100 may be configured to detect the at least one physical action and determine a normal area 210 and a bezel area 220 on the flexible display 110 based, at least in part on the detected at least one physical action.

In some examples, as depicted in FIG. 5A, the folding action which may be referred to a bending action that is stronger than a predetermined level may be applied to the flexible device 100 (or flexible display 110) along with a line 510. Then, flexible device 100 may be configured to determine the bezel area 520 to include the line 510 as shown in right side of FIG. 5A.

In another example, as depicted in FIG. 5B, the stretching action which is stronger than a predetermined level may be applied to the flexible device 100 along with a line 530. Then, flexible device 100 may be configured to determine the bezel area 540 to include the line 530 as shown in right side of FIG. 5B.

In yet another example, as depicted in FIG. 5C, the attaching action and the detaching action may be applied to the flexible device 100. In such examples, the flexible device 100 may include one or more sub-flexible devices 100-1 and 100-2 which can be attachable and/or detachable. As shown in FIG. 5C with flow of left to right, when the detaching action is applied to flexible device 100 along with line 550, and then flexible device 100 is divided to sub-flexible devices 100-1 and 100-2, each of sub-flexible devices 100-1 and 100-2 may be configured to determine line 550 as an edge of sub-flexible devices and determine a bezel area 560 to include line 550, respectively. Further, as shown in FIG. 5C with flow of right to left, when the attaching action is applied to sub-flexible devices 100-1 and 100-2, and then sub-flexible devices 100-1 and 100-2 are combined into flexible device 100, flexible device 100 may be configured to determine a normal area and a bezel area as a whole.

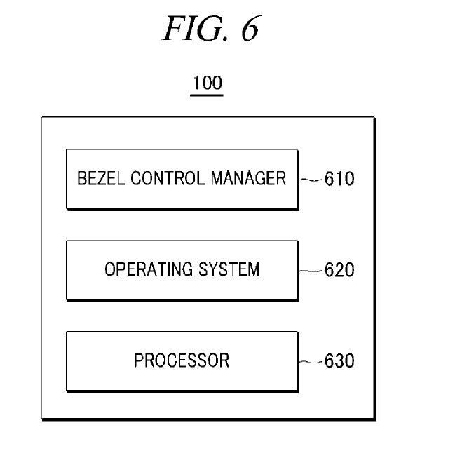

FIG. 6 schematically shows another example configuration of flexible device 100 in accordance with at least some embodiments described herein. As depicted in FIG. 6, flexible device 100 may include a bezel control manager 610, an operating system 620 and a processor 630. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or virtually any combination thereof. In some embodiments, bezel control manager 610 may be an application adapted to operate on operating system 620 such that a bezel displayed on a flexible display as described herein may be provided. Operating system 620 may allow bezel control manager 610 to manipulate processor 630 to implement the bezel displayed on the flexible display as described herein.

Processor 630 may be implemented as any processor, such as a complex instruction set computer (CISC) microprocessor, a reduced instruction set computing (RISC) microprocessor, a very long instruction word (VLIW) microprocessor, a processor implementing a combination of instruction sets, or other processor device. Processor 630 may be implemented as a dedicated processor, such as a controller, microcontroller, embedded processor, a digital signal processor (DSP), a network processor, a media processor, an input/output (I/O) processor, etc.

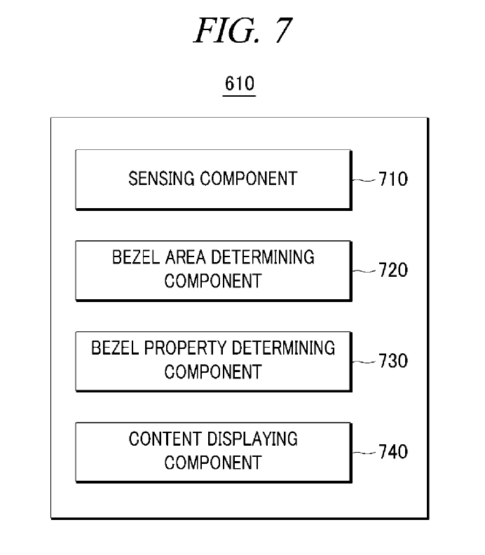

FIG. 7 schematically shows an example configuration of a bezel control manager 610 in accordance with at least some embodiments described herein. As depicted in FIG. 7, bezel control manager 610 may include a sensing component 710, a bezel area determining component 720, a bezel property determining component 730 and content displaying component 740. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or virtually any combination thereof.

Sensing component 710 may be configured to detect at least one physical action applied to flexible display 110 of flexible device 100. For example, but not limitation, sensing component 720 may include at a pressure sensor, a gyro sensor, a magnetic sensor, an optical sensor, a thermal sensor, an acoustic sensor, etc. Further, the at least one physical action may include, but not limitation, at least one of a folding action, a bending action, a stretching action, an attaching action, a detaching action or a cutting action.

Bezel area determining component 720 may be configured to determine a bezel area and a normal area on flexible display 110 based, at least in part, on the at least one physical action detected by sensing component 710. Bezel area determining component 720 may be configured to determine sizes and/or positions of the bezel area and the normal area on flexible display 110 based, at least in part, on the detected at least one physical action, and to determine the bezel area and the normal area based on the determined sizes and/or positions. In some examples, sensing component 710 may be configured to detect a folding action, and then bezel area determining component 720 may be configured to determine the bezel area to include an area folded by the folding area. In some other examples, sensing component 710 may be configured to detect a stretching action, and then bezel area determining component 720 may be configured to determine the bezel area to include an area stretched by the stretching action.

In some embodiments, sensing component 720 may be further configured to detect at least one value caused by the at least one physical action and bezel area determining component 720 may be further configured to determine the bezel area and the normal area based, at least in part, on the detected at least one value. In some examples, bezel area determining component 720 may be further configured to determine that the at least one value is higher than a predetermined threshold value, and to determine the bezel area, in response to the determination that the at least one value is higher than the predetermined threshold value.

Bezel property determining component 730 may be configured to determine a display property of the bezel area. For example, but not as a limitation, the display property of the bezel area may refer to at least one of a brightness, a resolution, a transparency, a visibility or a chroma of the bezel area. In some embodiments, bezel property determining component 730 may be configured to determine the display property of the bezel area based, at least in part, on the detected at least one physical action. For example, bezel property determining component 730 may be configured to change a resolution of content displayed on the bezel area, depending on a bended level of flexible device 100.

In some embodiments that flexible device 100 includes a touch screen, bezel property determining component 730 may be further configured to determine a touch sensing property of the bezel area. For example, but not as a limitation, the touch sensing property of the bezel area may include at least one of a touch sensitivity of the bezel area, or turn on/off of touch sensors of the bezel area. In some embodiments, bezel property determining component 730 may be configured to determine the touch sensing property of the bezel area based, at least in part, on the at least one physical action detected by sensing component 710. For example, bezel property determining component 730 may be configured to increase the touch sensitivity of the bezel area, if an application which may need relatively high touch sensitivity (e.g., a game application) is executed on flexible device 100. On the contrary, bezel property determining component 730 may be configured to decrease the touch sensitivity of the bezel area, if an application which may need a relatively low touch sensitivity (e.g., a web browser) is executed on flexible device 100.

Content displaying component 740 may be configured to display content on the bezel area and the normal area of flexible display 110. As a non-limiting example of the content displayed on the bezel area and the normal area may include a picture, a frame or a scene of video content, etc.

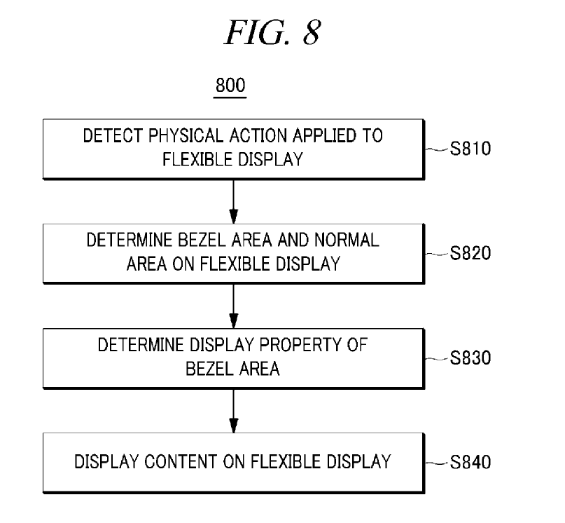

FIG. 8 shows an example processing flow 800 for implementing at least portions of a bezel area on a flexible display described herein. The process in FIG. 8 may be implemented by flexible device 100 including flexible display 110, sensor 120, display manager 130 and processor 140, as illustrated in FIG. 1. An example process may include one or more operations, actions, or functions as illustrated by one or more blocks S810, S820, S830 and/or S840. Although illustrated as discrete blocks, various blocks may be divided into additional blocks, combined into fewer blocks, or eliminated, depending on the desired implementation. Processing may begin at block S810.

At block S810 (Detect Physical Action applied to Flexible Display), sensor 120 may detect at least one physical action applied to flexible display 110. In some examples, sensor 120 may also detect at least one value caused by the at least one physical action applied to flexible display 110. Processing may proceed from block S810 to block S820.

At block S820 (Determine Bezel Area and Normal Area on Flexible Display), display manager 130 may determine a bezel area and a normal area on flexible display 110 based, at least in part, on the detected at least one physical action. At block S820, display manager 130 may determine sizes and/or positions of the bezel area and the normal area on flexible display 110 based on the detected at least one physical action, and determine the bezel area and the normal area based on the determined sized and/or positions. Processing may proceed from block S820 to block S830.

At block S830 (Determine Display Property of Bezel Area), display manager 130 may determine a first display property of the bezel area determined at block S820. Display manager 130 may determine the first display property of the bezel area to be different from a second display property of the normal area. For example, but not as a limitation, the first and second display property of the bezel area may refer to at least one of a brightness, a resolution, a transparency, a visibility or a chroma of the normal and bezel area. For example, display manager 130 may reduce brightness of the bezel area to be less than that of the normal area.

At block S840 (Display Content on Flexible Display), processor 140 may instruct flexible display 110 to display content on the normal area and the bezel which has the determined display property. As a non-limiting example of the content displayed on the bezel area and the normal area may include a picture, a frame or a scene of video content, etc.

The examples described above, with regard to FIGS. 1-8, may be implemented in a computing environment having components that include, but are not limited to, one or more processors, system memory, and a system bus that couples various system components. Further, the computing environment may include a variety of computer readable media that are accessible by any of the various components, and includes both volatile and non-volatile media, removable and non-removable media.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, but not limitation, computer readable media may comprise computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Communication media typically embodies computer readable instructions, data structures, program modules, or other data in a modulated data signal, such as carrier wave or other transport mechanism. Communication media also includes any information delivery media. The term modulated data signal means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

What is claimed is:

1. A flexible device, comprising:
a flexible display;
a sensor configured to detect at least one physical action applied to the flexible display;
a display manager configured to:
determine a first area and a second area on the flexible display based, at least in part, on the detected at least one physical action; and
determine a first display property of the first area to be different from a second display property of the second area; and
a processor configured to:
instruct the flexible display to display content based, at least in part, on the first and second display properties.

2. The flexible device of claim 1, wherein the at least one physical action includes a folding action, and
wherein the display manager is further configured to:
determine the first area to include an area folded by the folding action.

3. The flexible device of claim 1, wherein the at least one physical action includes a stretching action, and
wherein the display manager is further configured to:
determine the first area to include an area stretched by the stretching action.

4. The flexible device of claim 1, wherein the at least one physical action includes at least one of an attaching action, a detaching action or a cutting action.

5. The flexible device of claim 1, wherein the sensor is further configured to:
detect at least one value caused by the at least one physical action, and
wherein the display manager is further configured to:
determine the first area and the second area based, at least in part, on the detected at least one value.

6. The flexible device of claim 5, wherein the display manager is further configured to:
determine that the at least one value is higher than a predetermined threshold value; and
determine the first area, in response to the determination that the at least one value is higher than the predetermined threshold value.

7. The flexible device of claim 1, wherein the first or second display property includes at least one of a brightness, a resolution, a transparency, a visibility or a chroma of the first or second area.

8. The flexible device of claim 1, wherein the display manager is further configured to:
divide the first area into a plurality of sub-areas; and
respectively determine a display property of each of the plurality of sub-areas.

9. The flexible device of claim 1, wherein the flexible display includes a touch screen, and
wherein the display manager is further configured to:
determine a touch sensing property of the first area to be different from that of the second area.

10. The flexible device of claim 1, wherein the processor is further configured to:
instruct the flexible display to display the content on both of the first area and the second area based, at least in part, on the first and second display properties, respectively.

11. A non-transitory computer-readable storage medium having thereon computer-executable instructions that, in response to execution, cause one or more processors of a flexible device having a flexible display to perform operations, comprising:
detecting at least one physical action applied to the flexible display;
determining a first area and a second area on the flexible display based, at least in part, on the detected at least one physical action;
determining a first display property of the first area to be different from a second display property of the second area; and
displaying content on the flexible display based, at least in part, on the first and second display properties.

12. The non-transitory computer-readable storage medium of claim 11, wherein the at least one physical action includes a folding action, and
wherein the first area includes an area folded by the folding action.

13. The non-transitory computer-readable storage medium of claim 11, wherein the detecting the at least one physical action includes detecting at least one value caused by the at least one physical action, and
wherein determining the first area and the second area includes:
determine that the at least one value is higher than a predetermined threshold value; and
determining the first area, in response to the determination that the at least one value is higher than the predetermined threshold value.

14. The non-transitory computer-readable storage medium of claim 11, wherein the first or second display property includes at least one of a brightness, a resolution, a transparency, a visibility or a chroma of the first or second area.

15. The non-transitory computer-readable storage medium of claim 11, wherein the displaying content includes displaying the content on both of the first area and the second area based, at least in part, on the first and second display properties, respectively.

16. A method performed under control of a flexible device having a flexible display, comprising:
detecting at least one physical action applied to the flexible display;
determining a first area and a second area on the flexible display based, at least in part, on the detected at least one physical action;
determining a first display property of the first area to be different from a second display property of the second area; and
displaying content on the flexible display based, at least in part, on the first and second display properties.

17. The method of claim 16, wherein the at least one physical action includes a folding action, and
wherein the first area includes an area folded by the folding action.

18. The method of claim 16, wherein the detecting the at least one physical action includes detecting at least one value caused by the at least one physical action, and
wherein determining the first area and the second area includes:
determine that the at least one value is higher than a predetermined threshold value; and
determining the first area, in response to the determination that the at least one value is higher than the predetermined threshold value.

19. The method of claim 16, wherein the first or second display property includes at least one of a brightness, a resolution, a transparency, a visibility or a chroma of the first or second area.

20. The method of claim 16, wherein the displaying content includes displaying the content on both of the first area and the second area based, at least in part, on the first and second display properties, respectively.
